(19) United States
(12) Patent Application Publication
(10) Pub. No.: US 2011/0114614 A1
(43) Pub. Date: May 19, 2011

(54) COOLING DEVICE FOR WELDING DEVICE

(75) Inventors: Mats Flink, Laxa (SE); Pelle Johanson, Laxa (SE)

(73) Assignee: ESAB AB, Goteborg (SE)

(21) Appl. No.: 13/002,670

(22) PCT Filed: Jun. 17, 2009
(86) PCT No.: PCT/SE09/50750

§ 371 Date: Jan. 31, 2011

(30) Foreign Application Priority Data
Jul. 11, 2008 (SE) 0801668-5

(51) Int. Cl. B23K 9/00; F28D 15/00

(52) U.S. Cl. 219/136; 165/104.31

(57) ABSTRACT

A cooling device for liquid cooling of at least one member of a welding device and a welding device with such a cooling device is described. The cooling device comprises a coolant tank, an outlet pipe for coolant from the coolant tank to the member, which outlet pipe comprises an outlet for connection to the welding device, a return pipe for returning heated liquid from the member back to the coolant tank, which return pipe comprises an inlet for connection to the welding device, and a pump which is connected to the outlet pipe for pumping coolant from coolant tank to the member. The cooling device comprises means for preventing flow through at least one of the outlet pipe and the return pipe when the pump is shut off.

### TECHNICAL FIELD

The present invention relates to a cooling device for fluid cooling of a device, especially a welding gun or a welding head for MIG/MAG or TIG welding. The present invention also relates to a welding device with such a cooling device.

### BACKGROUND

In MIG/MAG and TIG welding water cooling of the welding gun with some of its parts, mainly connections, grip, current water cable and welding head, exist. The cooling device for providing water for cooling may be a separate unit or a part of the welding device and/or the feeder device for feeding welding wire to the welding area. The cooling device comprises a water tank, an outlet pipe for cooling water from the water tank to for example the welding grip, a return pipe for redirection of heated water from the welding grip back to the water tank and a pump which is connected to the outlet pipe for pumping of water from the water tank to the welding grip. The cooling device also comprises a cooler for cooling of the heated water in the return pipe. Usually, the water flow is controllable by controlling the speed of the pump.

During welding where the welding gun is at a considerably larger height than the water tank the water hoses may at least partly be emptied on water during longer interruptions in the welding. When the welding is resumed it will then take a while before water again flows through for example the welding handle. If welding is performed without satisfactory cooling of the welding handle there is a risk for the welding handle to be overheated and damaged. In order to avoid that welding is performed without satisfactory cooling such cooling devices are often equipped with a water flow indicator so that welding cannot be performed without flow of water through the welding handle. The water flow indicator is often arranged to sense whether there is any water flow during a predetermined time period which may be for example 2 seconds. If the water flow indicator does not sense any water flow during the predetermined time period, the weld is not started, wherein restart has to be demanded by the operator. If the height difference between the welding handle and the water tank is large, many starting attempts may be required before water has been pumped up to the welding handle. This may be very inconvenient for the operator.

### SUMMARY OF THE INVENTION

An object of the present invention is to provide a cooling device for a welding device which

At least one of these objects is fulfilled with a welding device.

Further advantages of the invention are achieved with the features of the dependent claims.

According to a first aspect of the invention a cooling device for liquid cooling of at least one member of a welding device is provided. The cooling device comprises a coolant tank, an outlet pipe for coolant from the coolant tank to the member, which outlet pipe comprises an outlet for connection to the welding device, a return pipe for redirection of heated liquid from the member back to the coolant tank, which return pipe comprises an inlet for connection to the welding device and a pump which is connected to the outlet pipe for pumping of coolant from the coolant tank to the member. The cooling device is characterized in that it comprises means for preventing flow through at least one of the outlet pipe and the return pipe when the pump is shut off, wherein said means for preventing flow comprises a first valve arranged on the outlet pipe and a second valve arranged on the return pipe, and wherein the second valve is a controllable valve.

With such a cooling device the coolant flow may be shut off during a period without risk of any of the outlet pipe and the return pipe being emptied on water. With a cooling device according to the invention welding may therefore be resumed immediately after restart of the pump. The first valve may be any type of valve. By providing also a second valve outflow of coolant from the member when the pump has been stopped is avoided with larger certainty.

The first valve may be a non-return valve. A non-return valve allows flow in one direction if there is a sufficiently large pressure in that direction, but prevents flow in the opposite direction.

The first valve may be a controllable valve. With a controllable valve the flow through the valve may be interrupted faster than with a non-return valve.

The first valve may be arranged on the outlet pipe. Such an arrangement of the first valve prevents the coolant from flowing out through the outlet pipe and also prevents coolant from flowing out through the return pipe if the pipe is sufficiently small or if the return pipe exits below the liquid surface in the coolant container.

The first valve may be arranged on the outlet pipe downstream the pump. Such a placement has proven to give satisfactory results during operation of the cooling device.

The first valve may be arranged on the return pipe. Such a placement ensures that the coolant cannot leave the member in the welding device as the orifice of the outlet pipe per definition must be placed below the liquid surface in the coolant container.

The cooling device may be arranged to shut off the controllable valve when the pump is shut off. It is advantageous to let both the pump as well as controllable valves be controlled by the same unit as shutting off of the pump and closure of the valve then easier may be done simultaneously.

According to a second aspect of the present invention a welding device for electric arc welding on a work piece is provided. The welding device comprises a welding head through which a welding wire is arranged to be fed, a voltage source for arrangement of an electrical voltage between the welding head and the work piece and a cooling device according to the first aspect of the present invention for cooling of at least one member of the welding device, which member is heated during operation of the welding device.

A welding device according to the second aspect of the present invention provides the same advantages as have been described in connection to the first aspect of the present invention.

The member of the welding device which is arranged for cooling of the cooling device may be the welding head.

In the following preferred embodiments of the invention will be described with reference to the appended drawings.

### SHORT DESCRIPTION OF THE DRAWINGS

FIG. 1 shows schematically a cooling device according to an embodiment of the present invention.

FIG. 2 shows schematically a welding device which comprises a cooling device according to an embodiment of the invention.

### DESCRIPTION OF PREFERRED EMBODIMENTS OF THE INVENTION

In the following description of preferred embodiments of the invention similar parts in different figures will be denoted with the same reference numeral. The drawings are only schematical and have the purpose of illustrating the invention.

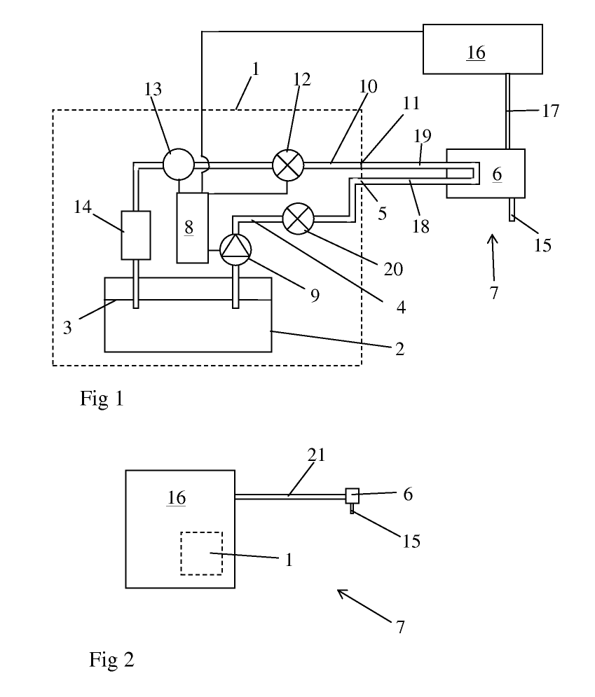

FIG. 1 shows schematically a cooling device 1 according to an embodiment of the present invention. The cooling device 1 is connected to a member, in the form of a welding head 6 of the welding device 7 for electrical arc welding, for liquid cooling of the welding head 6. The welding head 6 is arranged for feeding a welding wire 15 to a welding area. The welding device comprises a voltage source 16 which is connected to the welding head by means of a current cable 17, and which is arranged to feed current to the welding wire 15. The cooling device 1 comprises a coolant tank 2, in which there is arranged a coolant with a coolant level 3. The cooling device 1 also comprises an outlet pipe 4 with an outlet 5, for transfer of coolant from the coolant tank 2 to the welding head 6. The cooling device comprises a control unit in the form of a computer 8. On the outlet pipe 4 there is arranged a pump 9 for pumping of coolant from the coolant tank 2 to the outlet 5 and further to the welding head 6. The pump is connected to the computer and is arranged to be controlled by the computer. On the outlet pipe there is arranged a first valve 20 in the form of a non-return valve in order to prevent flow in the opposite direction from the welding head through the pump to the coolant container 2.

The cooling device 1 also comprises a return pipe 10 with an inlet 11 for return of heated coolant from the welding head 6 back to the coolant tank 2. On the return pipe there is arranged a second valve 12 in the form of a controllable valve in the form of a magnet valve, a flow monitoring member 13 for monitoring the coolant flow through the return pipe 10, and a cooler 14 for cooling of the heated coolant which enters the cooling device 1 through the inlet 11 before the coolant is returned to the coolant container. The second valve 12 is connected to the computer 8 which is arranged to control the second valve 12. The computer 8 is also connected to the flow monitoring member 13 for reception of flow information.

The welding head 6 is connected to the outlet 5 and inlet 11 of the cooling device 1 via a supply hose 18 and a return hose 19.

FIG. 2 shows schematically a welding device 7 which comprises a voltage source 16, a welding head for feeding a welding wire, and a cooling device 1 which is arranged together with the voltage source 16. The welding head is connected to the voltage source 16 by means of a cable 21 in which hoses as well as current cable extends.

During operation of a welding device and cooling device according to the invention an operator initiates welding by giving a commando to the computer 8 in any way. The computer will then start the pump 9 and open the second valve 12, in order to then await the reception of a flow signal from the flow monitoring member 13, which flow signal indicates that coolant flows through the flow monitoring member 13. Then the voltage source 16 is controlled to commence welding. When the welding is to be stopped the voltage source 16 is shut off first. Then the second valve 12 is closed and the pump 9 is shut off. Thanks to the first valve 20 not allowing flow of coolant in the outlet pipe in the direction towards the coolant container coolant is prevented from flowing out of any of the outlet pipe 4, the return pipe 10 and the hoses 18, 19. At restart of the welding device there is thus coolant in the entire coolant system, why the flow of coolant starts directly. Thus, the welding may be resumed immediately.

The described embodiments may be varied in many ways without departing from the spirit and scope of the invention which is limited only by the appended claims.

It is of course possible to let the controllable valve be something else than a magnet valve.

What is claimed is:

1-9. (canceled)

10. A cooling device for liquid cooling of at least one member of a welding device, the cooling device comprising: a coolant tank, an outlet pipe for coolant from the coolant tank to the member, which outlet pipe comprises an outlet for connection to the welding device, a return pipe for return of heated liquid from the member back to the coolant tank, which return pipe comprises an inlet for connection to the welding device, and a pump which is connected to the outlet pipe for pumping of coolant from the coolant tank to the member, means for preventing flow through at least one of the outlet pipe and the return pipe when the pump is shut off, wherein said means for preventing flow comprises a first valve arranged on the outlet pipe and a valve arranged on the return pipe, and wherein the second valve is a controllable valve.

11. A cooling device according to claim 10, wherein the first valve is a non-return valve.

12. A cooling device according to claim 10, wherein the first valve is a controllable valve.

13. A cooling device according to claim 10, wherein the first valve is arranged on the outlet pipe.

14. A cooling device according to claim 13, wherein the first valve is arranged on the outlet pipe downstream the pump.

15. A cooling device according to claim 10, wherein the first valve is arranged on the return pipe.

16. A cooling device according to claim 10, wherein the cooling device is arranged to close the controllable valve when the pump is shut off.

17. A welding device for electrical arc welding on a work piece, comprising: a welding head through which a welding wire is arranged to be fed, a voltage source for arrangement of an electrical voltage between the welding head and the work piece, a cooling device according to claim 10 for cooling of at least one member of the welding device, which member is heated during operation of the welding device.

18. A welding device according to claim 17, wherein the welding head is arranged to be cooled by the cooling device.
